(19) United States
(12) Patent Application Publication
(10) Pub. No.: US 2005/0255423 A1
(43) Pub. Date: Nov. 17, 2005

(54) Dental system for the investigation of the optical properties of tooth tissue with optical investigation device and calibration means

(75) Inventors: Alexander Hack, Biberach (DE); Sven Erdmann, Ulm (DE); Hans Heckenberger, Assmannshardt (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach/Riss (DE)

(21) Appl. No.: 11/126,647

(22) Filed: May 11, 2005

(30) Foreign Application Priority Data
May 14, 2004 (DE) 10 2004 024 164.3

(51) Int. Cl. A61C 3/00

(52) U.S. Cl. 433/29

(57) ABSTRACT

A calibrator is provided for carrying out a calibration of an investigation device, which has means for the generation of an excitation radiation, which is to be directed at a tooth tissue region to be investigated, a radiation detector and radiation evaluation for the detection and evaluation of a response radiation arising from the irradiated tooth tissue region in response to the irradiation, and a radiation transmission for the transmission of the excitation radiation and the response radiation, which includes at least a diagnosis probe for directing the excitation radiation at the tooth tissue region to be investigated and for detecting the response radiation, has a reference element, which for carrying out a calibration of the investigation device is to be irradiated by this device via the diagnosis probe. In accordance with the invention the calibrator has a repository via which the diagnosis probe is held in a defined position and/or orientation with regard to the reference element.

### BACKGROUND OF THE INVENTION

1. Field of the Invention

The invention relates to a dental system for the investigation of the optical properties of tooth tissue, in particular for the recognition of caries, plaque, bacterial infections, concretions and tartar, which has an optical investigation device and a calibration means for carrying out a calibration of the investigation device. Beyond this, the present invention relates to a calibration device for carrying out a calibration of a dental optical investigation device.

2. Related Technology

In dental diagnostics, optical investigation devices, with the aid of which for example caries, plaque, bacterial infection, concretions or tartar can be recognized, have long been known and known in different variants. It is common to all known devices that a tooth tissue region to be investigated is first irradiated with an excitation radiation, in response to which a response radiation is issued from the tooth. This response radiation may contain both the return reflected radiation of the same wavelength and also a fluorescence radiation. The response radiation is in turn detected and delivered to an evaluation unit which on the basis of the spectrum of the response radiation determines whether one of the above-mentioned substances is present or not. The known optical diagnostic methods and devices differ thereby in the employed wavelength(s) for the excitation radiation and in the evaluation of the detected response radiation. A first possibility consists in investigating whether there has arisen at the tooth a fluorescence radiation as reaction to the excitation radiation. Another possibility consists in, in the case of so-called reflection spectrometry, investigating which wavelengths are reflected in what manner from the tooth surface.

Known dental investigation devices for carrying out an optical diagnosis procedure have in principle means for the generation of an excitation radiation, which is to be directed onto the tooth tissue region to the investigated, detection means and evaluation means for detection and evaluation of a response radiation arising from the irradiated tooth tissue region as response to the irradiation, and transmission means for transmission of the excitation radiation and the response radiation. Usually, the transmission means include a so-called diagnosis probe, which is arranged on the dental handpiece which is provided for carrying out the investigation, and is constituted to direct the excitation radiation onto the tooth tissue region to be investigated. A further task of the diagnosis probe is to detect the response radiation and transmit it to the detection and evaluation means.

Although dental optical investigation devices are produced with the highest precision, with the passage of time there can arise an alteration in the measurement signal, which can be attributed to an ageing of the various components and to wear of the diagnosis probe. Thus, in order to obtain reproducible results, at regular intervals a calibration of the investigation device is carried out. Such a calibration is in particular also important when over a long period of time an exact indication is required, which for example is the case when monitoring measures are to be carried out over a long period of time of for example three to six months. Further, a calibration is also necessary because the probes are regularly exchanged, in order sterilize and disinfect them.

For carrying out of the calibration there is usually provided a calibration device, which has a reference element which reacts in a specific manner to irradiation with the excitation radiation. This reference element is of a certain material, for example ceramic, which upon irradiation with the excitation radiation generates a certain response radiation. For carrying out the calibration, the diagnosis probe of the optical investigation device is then directed onto the reference element and a measurement carried out. On the basis of the thereby received measurement signal, a calibration of the investigation device is then effected.

Known calibration means for carrying out a calibration of the investigation devices usually have a reference element on which the diagnosis probe is placed. The present invention now has the object of further developing the known calibration means so that the possibilities for carrying out the calibration are further improved. In particular it is to be ensured that the calibration is always carried out under the same conditions.

### GENERAL DESCRIPTION OF THE INVENTION

This object is achieved by means of a dental system for the investigation of the optical properties of tooth tissue, and by means of a calibration means.

In accordance with the invention it is provided that the calibration means has a repository via which the diagnosis probe of the investigation device is held in a defined position and/or orientation with regard to the reference element.

In accordance with the invention the calibration means is thus so configured that upon the carrying out of the calibration the diagnosis probe is fundamentally arranged in the same position and orientation with respect to the reference element. Through this there is achieved a high reproducibility of the measurement results and thereby the exactitude upon carrying out of the calibration is improved.

In accordance with an advantageous embodiment of the invention, the calibration means has a housing in which the reference element is mounted, wherein the repository is formed by means of a recess in the housing wall, the form of which is adapted to the contour of the diagnosis probe. In particularly it can be provided that the recess is formed in that outer side of the housing wall of the calibration means, whereby the housing further then has an opening through which the diagnosis probe extends in the reposed condition.

For the investigation of the optical properties of tooth tissue there are usually available differently configured probes, which are configured each in accordance with the area in which investigation is to be carried out. For investigation of the so-called approximal area or of tooth intermediate spaces there are mainly put to use for example probes which have an elongate light wedge of a light conducting material, at the forward end of which a coupling out of the excitation radiation to the side takes place. In the case of these probes it is of particular interest to attain a reproducible arrangement of the probe during the calibration, since otherwise large variations in the measurement signal can appear, which make impossible a calibration under conditions which remain the same.

In accordance with a preferred exemplary embodiment of the invention, the repository of the calibration means thus have means which makes possible a purposive aiming of the diagnosis probe in the direction towards the reference element. For example for this purpose the recess may have special markings or latching means, which in co-operation with the diagnosis probe ensure a correct alignment thereof.

Along with the above-mentioned probes, with which coupling in and coupling out of light is effected to the side, there are however also put to use probes for investigation in the fissure region, with which the light is coupled out in the direction of the longitudinal axis of the probe with the aid of a calotte-shaped tip. In order to make possible also for such probes an arrangement with regard to the reference element which is as reproducible as possible, in accordance with an advantageous further development it is provided that the reference element has a rotationally symmetrical, in particular a calotte-shaped, depression in its upper side, into which the tip of the probe is emplaced.

The employment of this rotationally symmetrical or calotte-shaped depression at the upper side of the reference element is also of advantage in the case of a second exemplary embodiment of the calibration means in accordance with the invention, with which the probe is held in a defined manner with the aid of an adapter. This adapter is placed on the housing of the calibration means, and may in particular be latchable with this. Thereby, the adapter is so configured that the tip of the probe comes to bear against the surface of the reference element and hereby in particular; enters into the depression. In this manner there is.-attained a particularly well reproducible arrangement of the probe, so that the quality of the calibration is very high.

Through the solution in accordance with the invention it is thus ensured that in the case of very different probes, a calibration of the optical investigation device can fundamentally be carried out under the same conditions, so that also investigations carried out over a long period of time can be compared with one another.

### BRIEF DESCRIPTION OF THE DRAWINGS

Below, the invention will be described in more detail with reference to the accompanying drawings. There is shown:

FIG. 1 a dental optical investigation device in the form of a handpiece;

FIG. 2a the configuration and arrangement of the main components for optical caries diagnosis;

FIGS. 2b and 2c representations of FIG. 2a to an enlarged scale;

FIG. 3 a second variant of the investigation device with a further diagnosis probe;

FIG. 4 a side view of a first exemplary embodiment of a calibration means with diagnosis probe in place;

FIG. 5 the arrangement of the calibration means and the diagnosis probe, in lateral section;

FIG. 6 a perspective illustration of the view of FIG. 5;

FIG. 7 a view from above of the arrangement of FIG. 6;

FIG. 8 a sectional illustration of a diagnosis probe in place in the calibration means according to the invention, which probe is provided for investigations in the fissure region;

FIG. 9 a second exemplary embodiment of a calibration means, in lateral section, and

FIG. 10 the calibration means of FIG. 9 in a view from above.

### DETAILED DESCRIPTION OF THE DRAWINGS

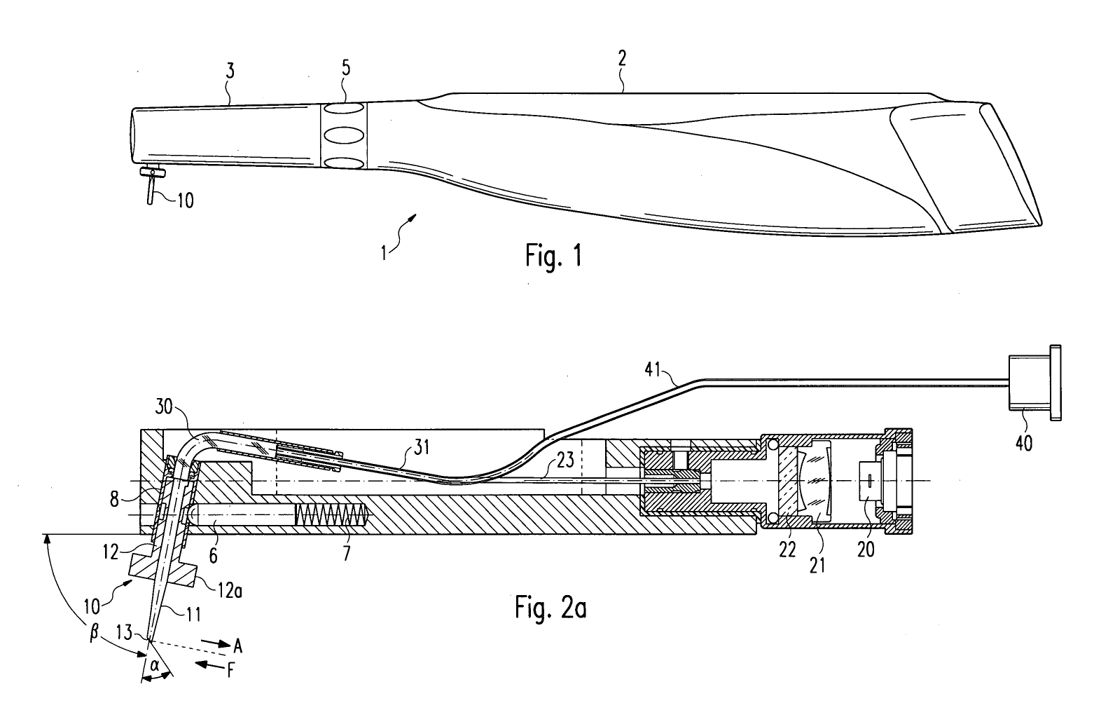

FIG. 1 shows the external view of a dental investigation device for the investigation of tooth tissue, in particular for the recognition of caries, plaque, bacterial infection, concretions or tartar. In the illustrated exemplary embodiment, the device is configured as handpiece 1, which can be put to use completely independently of further external consoles or evaluation and depiction units. The elongate grip body 2 has for this purpose at its forward head region 3 a probe 10 standing out slightly obliquely downwardly, which is provided for the transmission of an excitation radiation onto the tooth tissue region to be investigated and for the transmission of response radiation irradiated back from the tooth to an evaluation unit arranged in the handpiece 1. The precise configuration and function of the diagnosis probe 10 will be described in more detail below.

It is to be remarked that for the most part also optical investigation devices are put to use with which certain components are arranged in external consoles or the like. For example the means for the evaluation of the response radiation and for the representation of the measurement result are often arranged in table apparatuses, with which the handpieces are connected via connection tubes. The present invention is independent thereof, and relates both to such investigation devices which are configured as fully autonomously working handpieces, and also devices in which the handpiece is connected with other operational means.

In the forward region 3 of the handpiece I illustrated in FIG. 1, there is provided a ring switch, which can be employed for the activation of the excitation radiation source. This ring switch may be component of a removeable sleeve 2, which can be drawn off the remaining components of the handpiece 1, through which a simple and sterilization of those parts which come into contact with the patient is make possible.

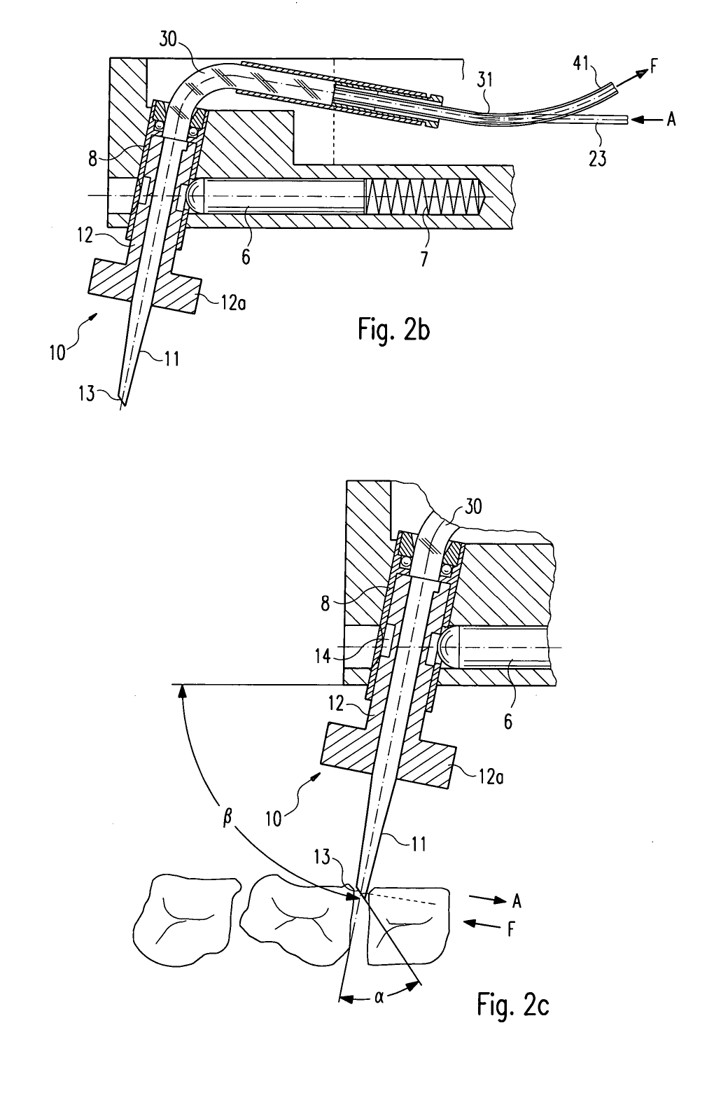

FIGS. 2a to 2c show the components of the investigation device which are required for the recognition of the above-mentioned materials at an investigated tooth tissue region. As with the known optical investigation devices, the investigation is effected in that the tooth tissue to be investigated is exposed to an excitation radiation and the response radiation arising from the radiation is detected and evaluated. The main components of the investigation device are thus on the one hand a light source for the generation of the excitation radiation, evaluation means for the evaluation of the response radiation and transmission means for transmitting the excitation radiation to the region to be investigated and for transmitting the response radiation to the evaluation means.

In the case of the illustrated handpiece 1, the light source for the generation of the excitation radiation is formed by means of a laser diode 20, which generates a virtually monochromatic light. In particular the excitation radiation may lay in the region between 600 nm and 670 nm, preferably at ca. 655 nm, since at such a wavelength the-best possible compromise can be achieved between the output power of the laser diode 20 and the spectral difference between the excitation radiation and the response radiation given back from the tooth surface. It is to be remarked that the function of an optical investigation device is here explained on the basis of the example of fluorescent diagnosis in which the fluorescence radiation arising at the tooth surface as a reaction to the irradiation is evaluated. Alternatively thereto, there is however also the possibility of using other wavelengths for the excitation and/or response radiation or to carry out investigation, in the scope of a so-called reflection spectrometry, of which wavelengths are reflected in what manner from the tooth surface.

With the aid of a lens 21 arranged before the laser diode 20, and an optical filter 22 which further restricts the light emitted from the laser diode 20 to the desired wavelength region, an excitation radiation A is then generated and coupled into a first light conductor 23. This light conductor 23 may be an individual light fiber having a diameter of ca. 0.5 mm; however there is also the possibility of forming the light conductor 23 from a plurality of individual light conductor fibers. At its forward end the light conductor 23 borders on a curved fiber rod 30, of a likewise light conducting material, through which the excitation radiation is deflected and coupled into the end face of the diagnosis probe 10.

In the illustrated exemplary embodiment there is involved a probe 10 for the investigation of tooth intermediate spaces. The significant element of the probe 10 is an elongate light wedge 11 of a transparent material, at the lower end of which the excitation radiation A is coupled out and directed onto the tooth region to be investigated. As material for the light wedge 11 there can be employed for example plastic or sapphire, whereby plastic is advantageous with regard to the lesser danger of breakage and lesser production costs, but however has disadvantages with regard to manifestations of wear and the working life resulting therefrom.

As can be understood in particular from the illustration in FIG. 2c, the light is to be coupled out laterally of the longitudinal axis of the light wedge 11, in order to make possible an investigation of the tooth intermediate spaces. For this purpose, the forward end of the light wedge 11, which is of a transparent material, is provided with a bevel 13 which includes with the longitudinal axis of the light wedge an angle α of ca. 40 to 45°. The light incident from above is then totally reflected at the bevel 13 and coupled out of the light wedge 11 to the side. Additionally or alternatively, the bevel 13 may be mirrored, in order to attain the deflection of the light.

The return transmission of the response radiation F, arising at the tooth surface due to the irradiation, is effected in similar manner in the reverse direction. First, the response radiation falls laterally into the light wedge 11 and is again reflected at the bevel 13 and thus directed to the end face of the probe 10 and coupled into the fiber rod 30. From the end of the fiber rod 30, which in turn is preferably of a plurality of individual fibers having a diameter of 0.1 mm and has overall a diameter of ca. 1.4 mm, the response radiation is then coupled into a light fiber bundle 31, which on the one hand is of the excitation radiation fiber or fibers 23 for the excitation radiation A and on the other hand is of a detection fiber 41 for the transmission of the response radiation F.

Via the detection fiber 41, which preferably has a diameter of 0.25 mm, there is effected the passing on to a detection device 40, the task of which is to detect the response radiation radiated back from the tooth surface, to analyze the response radiation and on the basis of the measurement result to determine whether one of the fluorescent substances mentioned above is present at the investigated tooth surface or not.

With regard to the diagnosis probe 10 it is to be remarked that this is mounted rotatably by 360° C. in the head region 3 of the handpiece 1 so that the handpiece 1 can be brought to the tooth to be investigated in a very flexible manner. The probe 10 is thereby latched with the head region 3 of the handpiece 1 and can be removed in a very simple manner—e.g. for purposes of cleaning or for replacement by another probe. For this purpose there are provided in the head region 3 of the handpiece 1 first a cylinder shaped guide 8 for the probe 10 and a latching pin 6, which with the aid of a spring 7 presses against the probe 10 and therewith holds this in the emplaced position within the guide 8. The forward hemispherical shaped end region of the latch pin 6 thereby engages into a circumferential recess 14 of a holder 12 for the light wedge 11, so that the probe 10 is mounted securely within the handpiece 1 but at the same, time rotatably. A rotation of the probe 12 by hand is thereby facilitated by means of a disk or ring shaped annex 12a on the holder 12, which with the fingers can readily be grasped and rotated by a user of the handpiece 1 The holder 12 itself has an elongate bore, in which the light wedge 11 is emplaced, whereby the possibility arises of exchanging the light wedge 11.

It is further to be remarked that with respect to the handpiece longitudinal axis the diagnosis probe 10 is held not at a right angle, but preferably slightly obliquely at an angle β of ca. 80°. It has been found that through this a particularly ergonomically favourable handling of the investigation device in accordance with the invention is attained.

The releasable holding of the probe 10 on the one hand provides the advantage that the probe 10, after each investigation, can be removed and cleaned and disinfected separately from the remaining components of the handpiece 1. On the other hand, there is however also the advantage that the probe 10 can be easily exchanged and replaced by a differently configured probe. Through this there is the possibility of making available differently formed probes, which can be configured in dependence upon the location or surface configuration of the tooth site to be investigated.

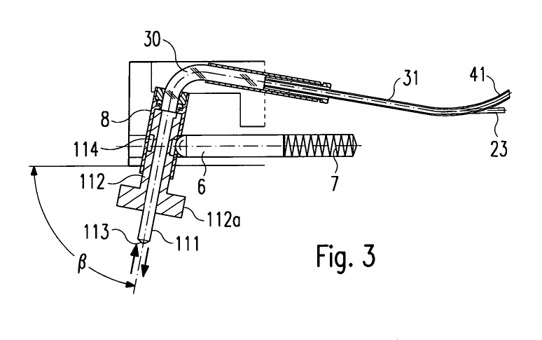

FIG. 3 shows a further probe, which can usually put to use in an optical investigation device. In the case of the probe 110 illustrated in FIG. 3 there is involved a probe which is provided for investigations in the fissure region—that is for investigation of the chewing surfaces of the teeth or of smooth surfaces or tooth outer surfaces. In contrast to the probe 10, illustrated in the previous Figures, for investigation of the approximal region or the region between teeth, the probe 110 has no bevel at the probe tip but instead has a truncated cone-shaped light exit tip 113. The probe 110 is again of an elongate light wedge 111 of a light conducting material having a light exit tip 113, whereby the light wedge 113 is held by means of a holder 112 with a disc-shaped annex 112a, which in the rearward region has a peripheral recess 114, via which a latching with the handpiece 1 is attained.

The probes 10 and 110 illustrated in FIGS. 2a to 2c and 3 must be regularly exchanged in use of the investigation device. The reason for this may be that other regions of a tooth are to be investigated and correspondingly the employment of a differently configured probe is needed. Beyond this, of courses, a change of the probe is also necessary for reasons of hygiene, in order to clean and/or sterilize the probes after use.

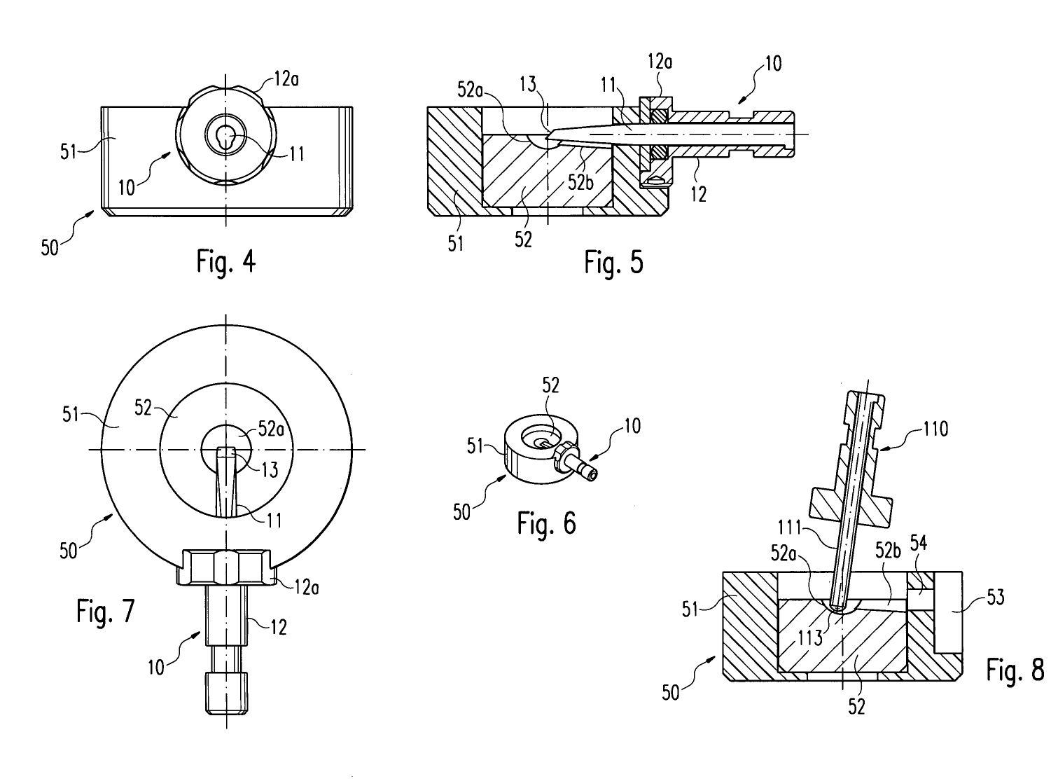

Since, however, through a change of the probes the relationship upon the transmission of the excitation and response radiation alter, and beyond this also manifestations of wear can appear with the passage of time, it is necessary to regularly calibrate the optical investigation device. A calibration means which makes possible in a particularly effective manner a reproducible arrangement of the probe and thus a very exact calibration, will now be explained with reference to FIGS. 4 to 8.

The calibration means 50 in accordance with the invention, illustrated in FIGS. 4 to 8, is of a pot-shaped housing 51 with a cylinder shaped wall, which is provided for mounting of a reference element 52. The reference element 52 is a ceramic element or another material which in a specific manner reacts to the excitation radiation of the investigation device. Instead of a cylindrical form there can be selected for the calibration means 50 also any other suitable form.

The calibration of the investigation device is to be carried out in that the probe is directed towards the reference element 52 and a measurement carried out in the usual manner, whereby on the basis of the measurement result the calibration of the investigation device is effected.

In order to obtain reproducible results and to make possible an exact calibration of the investigation device, it is necessary that the probe is in principle arranged in the same manner with regard to the reference element. In accordance with the invention, for this purpose measures are provided on the calibration means 50 which ensure this.

As it can be understood from the illustrations in FIGS. 4 to 7, there is provided in the housing wall a recess 53 in which the probe 10 for the investigation of the approximal space or the tooth intermediate space can be mounted. The contour of this recess 53 thereby corresponds at least partially to the dimensions of the ring-shaped annex 12a, so that a defined mounting of the probe 10 with regard to the reference element 52 is ensured. In the housing wall there is provided, beyond this, a through-opening or bore 54 through which the elongate light wedge 11 extends, whereby the dimensions of the housing 51 are overall so selected that the probe tip of the light wedge 11 is mounted over the center of the reference element 52.

At the recess 53 or the housing wall of the calibration device 50, measures may be provided which ensure that the probe 10 is correctly oriented with regard to the reference element 52. For carrying out the calibration it is necessary—as can be understood in particular from the illustration in FIG. 5—that the bevel 13, necessary for the coupling out of the excitation radiation to the side, is so directed that the light is direct perpendicularly onto the reference element 52. Appropriate measures can be constituted for example by means of—non-illustrated—latch elements or markings in the housing wall.

As can be understood from the illustrations, due to these measures it is thus ensured that the diagnosis probe 10, in each calibration, is arranged and directed in that same manner with regard to the reference element 52, so that in the carrying out of the calibration the same conditions are always present and correspondingly a high reproducibility is attained.

In order to ensure that the probe 10, more precisely the probe tip 13 out of which the excitation radiation is coupled, is arranged in the immediate vicinity of the reference body 52, there is provided a recess 52b, provided from the center to the opening 54 in the housing wall, within which recess the elongate light wedge 11 of the probe 10 is mounted.

Beyond this, the reference element 52 also has a calotte-shaped depression 52a in the center of the surface, which in accordance with the illustration in FIG. 8, is provided to receive the probe tip of the probe 110, which is provided for investigation in the fissure region. In contrast to the probe 10 for investigation of the approximal space, with this probe 110 for the fissure region a certain orientation of the probe tip or of the light wedge 111 is less important, since with this probe 110 the excitation radiation exits fundamentally in the direction of the longitudinal axis. It is however necessary that the calotte-like probe tip 113 comes to bear on the reference element 52 as exactly as possible.

Through the calotte-shaped recess 52a it is now ensured that the probe tip 113 is fundamentally arranged under the same conditions with regard to the surface of the reference element 52. Thus, also for this probe type, a more exact calibration is made possible. Also the calibration of a so-called paroprobe, which is provided for investigation of tooth gum pockets and in particular for the localization of subgingival concretions at tooth roots, can be carried out with the aid of the calotte-shaped recess 52a. Such a probe is flatted straight at the outermost end of its tip, through which a very slim light exit with a small diameter is attained, so that excitation radiation is directed onto a site to be investigated in a very concentrated manner. Also with this probe,-the light exit and light entry is effected in the direction of the longitudinal axis, so that through the configuration of the recess 52a there is again possible a calibration under conditions which remain the same.

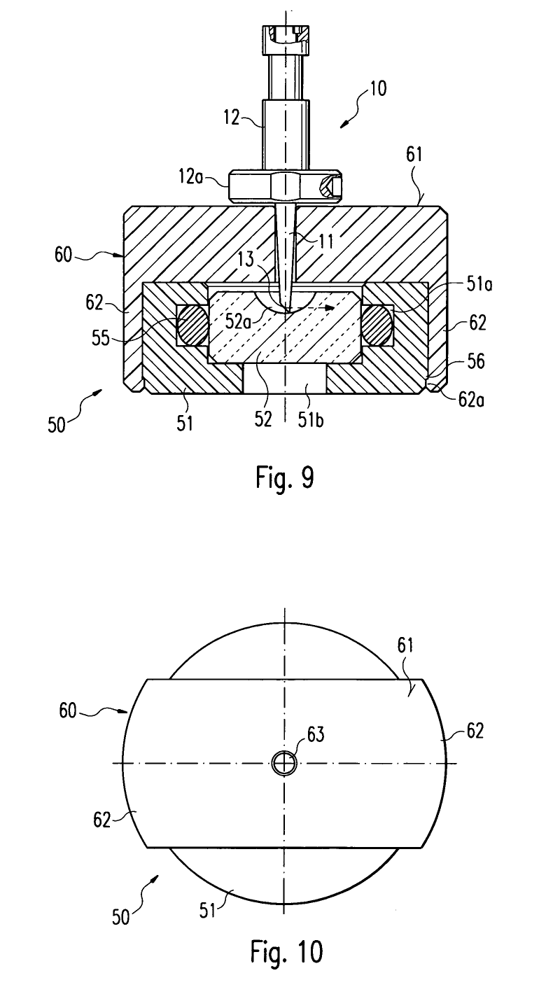

A variant of the calibration means illustrated in FIGS. 4 to 8 is illustrated in FIGS. 9, and 10. Here, the same elements of the calibration means are provided with the same reference signs. Again, the calibration means 50 are initially of a housing 51, in which a reference element 52 is mounted. In the present case, the reference element 52 is fixed with the aid of a-flexible O-ring 55 which is arranged within a ring-shaped housing recess 51a. Via an opening 51b provided at the underside of the housing 51, the reference element 52 can then ejected towards the upper side, if an exchange of the reference element 52 is necessary. This kind of exchangeable arrangement of the reference element in the housing 51 can also be provided, of course, with the previous exemplary embodiment of the calibration means in accordance with the invention.

In contrast to the exemplary embodiment according to FIGS. 4 to 8, a defined arrangement of the probe—in particular of the probe 10 for investigation of the approximal space—is effected not via a recess provided in the side wall of the housing 51, but instead with the aid of a bracket-shaped adapter 60, which can be put in place from the upper side on the cylinder-shaped housing 51 of the calibration means. Corresponding to the illustration, the adapter 60 is of an approximately rectangular, horizontally directed base surface 61, which at its end side has two downwardly directed clamping arms 62, which upon placing of the adapter 60 on the housing 51 are pushed over the side wall of the housing 51. Via latch projections 62a, provided at the undersides of the arms 62, which cooperate with corresponding projections 56 of the housing 51, a secure holding of the adapter 60 is ensured.

In the center of the base surface 61 of the adapter 60 there is provided a through-bore 63 through which the light wedge 11 of the probe 10 can be pushed. The thickness of the base plate 61 is thereby so dimensioned that when the ring-shaped annex 12a of the holder 12 of the probe 10 bears on the upper side of the base surface 61, the probe tip 13 likewise comes into bearing against the reference element. More precisely, the probe tip 113 enters into the rotationally symmetrical recess 52a of the reference element 52 and comes to bear against the base side of the recess 52a.

Also in this manner it is ensured that the probe tip 113 is directed in a desired manner at the reference element 52. Since the probe 10 is fundamentally arranged at a stop, a high repetition exactitude is attained, which for the carrying out of the calibration is of particular relevance. Further, in this case no axial alignment of the probe 10 is necessary, since due to the rotationally symmetrical configuration of the recess 52a the same conditions are always present. In similar manner, that is with the aid of the adapter, otherwise other probes, also the probe 110 illustrated in FIG. 8, can be arranged, whereby however the employment of the adapter is not unavoidably necessary with this probe type.

The advantage of this second configuration of the calibration means 50 in accordance with the invention consists in that due to the arrangement in contact with the surface of the reference element 52 a particularly good reproducibility is attained. With the exemplary embodiment according to FIGS. 4 to 8, in contrast, the approximal probe hangs over the recess 52a of the reference element 52. When, now, instead of sapphire probes, plastic probes find employment, due to possible inexactitudes the plastic probes could be bent upon insertion into the device. Through this there can arise slight spacing variations which lead to significant variations in the signal values, which in the end reduces the exactitude upon carrying out of the calibration. These disadvantages are avoided with the configuration in accordance with FIGS. 9 and 10.

From the above it can be understood that by means of specific measures at the calibration means it is ensured that the investigation probes of the optical investigation device are fundamentally arranged and directed in the same manner with regard to the reference element or its surface. The unavoidable calibrations of the investigation device can thus fundamentally be carried out under the same conditions, through which particularly exact results are attained. Through this it is ensured that also measurements taken over a long period of time are comparable with one another.

1. Dental system for the investigation of the optical properties of tooth tissue,
comprising
a) an optical investigation device comprising
an excitation radiation generator, which radiation is to be directed at a tooth tissue region to be investigated,
a radiation detector and a radiation evaluator for the detection and evaluation of a response radiation arising from the irradiated tooth tissue region in response to the irradiation and
a transmitter for the transmission of the excitation radiation and the response radiation, which transmitter includes at least a diagnosis probe for directing the excitation radiation at the tooth tissue region to be investigated and for detecting the response radiation, and
b) calibrator having a reference element, which for carrying out a calibration of the investigation device is to be irradiated by this device via the diagnosis probe,
the calibrator having a repository via which the diagnosis probe is held in a defined position and/or orientation with regard to the reference element.

2. Dental system according to claim 1,
wherein
the calibrator has a housing in which the reference element is mounted, and
wherein the repository is formed by a recess in the housing wall, the shape of which is adapted to the contour of the diagnosis probe.

3. Dental system according to claim 2,
wherein
the recess is formed in the outside of the housing wall, wherein the housing further has an opening through which the diagnosis probe extends in its reposed condition.

4. Dental system according to claim 3,
wherein
the reference element has a recess extending to the housing wall, through which the diagnosis probe extends in its reposed condition.

5. Dental system according to claim 4,
wherein
the recess extends from the middle of the reference element to the housing wall.

6. Dental element according to claim 1,
wherein
the diagnosis probe has an elongate light wedge of a light conducting material, at a forward end of which light wedge a coupling out of the excitation radiation and a coupling in of the response radiation takes place to the side,
wherein the repository of the calibrator has a device for aligning the diagnosis probe with regard to the reference element.

7. Dental system according to claim 2,
wherein
the recess has markings which ensure a correct alignment of the diagnosis probe.

8. Dental system according to claim 1,
wherein
the reference element has a central depression.

9. Dental system according to claim 8,
wherein
the depression is configured rotationally symmetrically.

10. Dental system according to claim 8,
wherein
the depression has the form of a calotte.

11. Dental system according to claim 2,
comprising
an adapter, for a defined holding of the diagnosis probe, positioned on the housing of the calibrator.

12. Dental system according to claim 11,
wherein
the adapter is latchable with the housing of the calibration means calibrator.

13. Dental system according to claim 11,
wherein
the adapter has a horizontally directed base surface, which contains an opening for the mounting of the diagnosis probe.

14. Dental system according to claim 13,
wherein
the adapter is configured such that the tip of the diagnosis probe bears upon the surface of the reference element.

15. Dental system according to claim 8,
wherein
a tip of the diagnosis probe enters into the depression of the reference element.

16. Calibrator for carrying out a calibration of an investigation device which has
an excitation radiation generator, which radiation is to be directed at a tooth: tissue region to be investigated,
a radiation detector and a radiation evaluator for the detection and evaluation of a response radiation arising from the irradiated tooth tissue region in response to the irradiation and
a radiation transmitter for the transmission of the excitation radiation and the response radiation, which include at least a diagnosis probe for directing the excitation radiation at the tooth tissue region to be investigated and for detecting the response radiation (F),
wherein the calibrator has a reference element, which for carrying out a calibration of the investigation device is irradiated by said device via the diagnosis probe, and
wherein
the calibrator has a repository via which the diagnosis probe is held in a defined position and/or orientation with regard to the reference element.

17. Calibrator according to claim 16,
comprising
a housing in which the reference element is mounted,
wherein the repository is formed by means of a recess in the housing wall, the shape of which is adapted to the contour of the diagnosis probe.

18. Calibrator according to claim 16,
wherein
the recess is formed in the outside of the housing wall, wherein the housing further has an opening through which the diagnosis probe extends in its reposed condition.

19. Calibrator according to claim 18,
wherein
the reference element has a recess extending to the housing wall, through which the diagnosis probe extends in its reposed condition.

20. Calibrator according to claim 19,
wherein
the recess extends from the middle of the reference element to the housing wall.

21. Calibrator according to claim 16,
wherein
the diagnosis probe has an elongate light wedge of a light conducting material, at a forward end of which light wedge a coupling out of the excitation radiation and a coupling in of the response radiation takes place to the side,
wherein the repository of the calibrator has a device for aligning the diagnosis probe with regard to the reference element.

22. Calibrator according to claim 17,
wherein
the recess has markings which ensure a correct alignment of the diagnosis probe 4.

23. Calibration means Calibrator according to any of claim 16,
wherein
the reference element has a central depression.

24. Calibrator according to claim 23,
wherein
the depression is configured rotationally symmetrically.

25. Calibrator according to claim 24,
wherein
the depression has the form of a calotte.

26. Calibrator according to claim 17,
comprising
an adapter for a defined holding of the diagnosis probe, on the housing of the calibrator.

27. Calibrator according to claim 26,
wherein
the adapter is latchable with the housing of the calibrator.

28. Calibrator according to claim 26,
wherein
the adapter has a horizontally directed base surface, which contains an opening for mounting of the diagnosis probe.

29. Calibrator according to claim 28,
wherein
the adapter is configured such that a tip of the diagnosis probe bears upon the surface of the reference element.

30. Calibrator according to claim 23,
wherein
a tip of the diagnosis probe enters into the depression of the reference element.
